(19) United States
(12) Patent Application Publication
(10) Pub. No.: US 2025/0314106 A1
(43) Pub. Date: Oct. 9, 2025

(54) POWER LATCH ASSEMBLY WITH ELECTRIC MOTOR HAVING MOTOR SHAFT WITH AXIAL FREE PLAY ELIMINATION MOUNTING

(71) Applicant: MAGNA CLOSURES INC., Newmarket (CA)

(72) Inventors: Francesco CUMBO, Newmarket (CA); Dunia SARDELLI, Newmarket (CA)

(21) Appl. No.: 19/097,386

(22) Filed: Apr. 1, 2025

Related U.S. Application Data
(60) Provisional application No. 63/574,897, filed on Apr. 4, 2024.

(51) Int. Cl. E05B 79/08; E05B 15/04; E05B 81/06; E05B 81/34; E05B 85/02

(52) U.S. Cl. CPC E05B 79/08; E05B 81/06; E05B 81/34; E05B 85/02; E05B 2015/0437

(57) ABSTRACT

A power actuator for a latch of a motor vehicle closure panel includes a housing having a first housing portion and a second housing portion. An electric motor is supported between the first housing portion and the second housing portion. The electric motor has a drive shaft extending along an axis between opposite ends. A drive gear is fixed to the drive shaft and a driven gear is meshed with the drive gear. An annular seal is compressed between the first housing portion and the second housing portion. A first bias member extends from the annular seal into engagement with one of the opposite ends of the drive shaft and a second bias member extends from the annular seal into engagement with the other of the opposite ends of the drive shaft. The first and second bias members are formed as a monolithic piece of material with the annular seal.

### CROSS-REFERENCE TO RELATED APPLICATION

This application claims the benefit of U.S. Provisional Application Ser. No. 63/574,897, filed Apr. 4, 2024, which is incorporated herein by way of reference in its entirety.

### FIELD

The present disclosure relates generally to vehicle closure members, and more particularly to power actuators for latches of vehicle closure members.

### BACKGROUND

This section provides background information related to vehicle closure panels and latch power actuators therefor to provide a better understanding of currently available configurations and adaptations of such vehicle closure panels and latch power actuators. However, the information provided in this section is not necessarily considered to be prior art with respect to the inventive concepts associated with the present disclosure.

Power actuators are often used in automotive vehicles to power a latch of a vehicle closure panel. Such actuators typically include a motor and gear assembly operably coupled to the latch via a cable or rod. Commonly, the motor and gear assembly of the actuator are operably coupled to one another for selective coupled engagement to transfer torque from the motor to the gear assembly and for selective decoupled relation with one another to prevent the transfer of torque between the motor and the gear assembly. Known gear assemblies include a drive gear fixed to a drive shaft of the motor and a driven gear of a gear train. Although such known drive gear and driven gear arrangements can prove effective in transferring torque between the motor and the gear assembly, they come with some potential drawbacks. For example, axial free play, also referred to as axial lash or slop between the drive gear and the driven gear and within the drive gear results in inefficiencies to torque transfer and the precise timing thereof, which ultimately results in less than optimal performance, as well as potentially reduced operable life of the motor and latch. Further yet, axial free play can result in undesirable vibration and noise.

Thus, for at least those reasons discussed above, a need exists to develop closure panel assemblies and power actuators therefor.

### SUMMARY

This section provides a general summary of some of the objects, advantages, aspects and features provided by the inventive concepts associated with the present disclosure. However, this section is not intended to be considered an exhaustive and comprehensive listing of all such objects, advantages, aspects and features of the present disclosure.

In accordance with one aspect, the present disclosure is directed to a vehicle closure panel and a power actuator for a latch of the vehicle closure panel which advances the art and improves upon currently known vehicle closure panels and power actuators for such vehicle closure panels.

In accordance with another aspect, the present disclosure is directed to a vehicle closure panel and a cinch power actuator for a latch of the vehicle closure panel which advances the art and improves upon currently known vehicle closure panels and cinch power actuators for such vehicle closure panels.

It is a related aspect to provide a power actuator having a drive shaft fixed to a drive gear, wherein the drive shaft and drive gear are axially biased to remove axial play.

In accordance with these and other aspects, a power actuator for a latch of a motor vehicle closure panel includes a housing, with an electric motor supported in the housing. The electric motor has a drive shaft extending along an axis between opposite ends for rotation about the axis in response to energization of the electric motor. A drive gear is fixed to the drive shaft. A first bias member imparts a first bias along the axis in a first direction on one of the opposite ends of the drive shaft, and a second bias member imparts a second bias along the axis in a second direction, opposite the first direction, on the other of the opposite ends of the drive shaft to inhibit the drive shaft from having axial play.

In accordance with a further aspect of the disclosure, the housing includes a first housing portion having a first annular outer periphery and a second housing portion having a second annular outer periphery, the first annular outer periphery and the second housing portion mating with one another.

In accordance with a further aspect of the disclosure, an annular seal is compressed between the first housing portion and the second housing portion, the first bias member extending inwardly from the annular seal and the second bias member extending inwardly from the annular seal.

In accordance with a further aspect of the disclosure, the first bias member and the second bias member are formed as a monolithic piece of material with the annular seal.

In accordance with a further aspect of the disclosure, at least one of the first housing portion and the second housing portion has an annular recess, the annular seal disposed in the annular recess.

In accordance with a further aspect of the disclosure, at least one of the first housing portion and the second housing portion has pockets, the first bias member and the second bias member each having an enlarged central body portion disposed in the pockets to inhibit misalignment of the first bias member and the second bias member relative to the axis of the drive shaft.

In accordance with a further aspect of the disclosure, the opposite ends of the drive shaft have channels fixed thereto, the first bias member having a first end disposed in one of the channels and the second bias member having a second end disposed in the other of the channels.

In accordance with a further aspect of the disclosure, the first bias member has a first end imparting the first bias on the drive shaft and the second bias member has a second end imparting the second bias on the drive shaft, the first bias member having a hollowed cavity between the first end and the enlarged central body portion of the first bias member, the second bias member having a hollowed cavity between the second end and the enlarged central body portion of the second bias member.

In accordance with a further aspect of the disclosure, the opposite ends of the drive shaft have channels fixed thereto, the first bias member having a first end disposed in one of the channels and the second bias member having a second end disposed in the other of the channels.

In accordance with a further aspect of the disclosure, a driven gear is disposed within the housing, the driven gear arranged in meshed engagement with the drive gear for rotation in response to rotation of the drive gear.

In accordance with a further aspect of the disclosure, the driven gear is arranged to rotate about a driven gear axis, the driven gear axis extending transversely to the axis of the drive shaft, the first bias and the second bias inhibiting lash between the drive gear and the driven gear.

In accordance with a further aspect of the disclosure, a method of inhibiting axial play of a drive shaft of a latch power actuator includes disposing a first bias member in engagement with a first end of the drive shaft to impart a first bias on drive shaft along a central longitudinal axis of the drive shaft in a first direction toward an opposite second end of the drive shaft. Further, disposing a second bias member in engagement with the second end of the drive shaft to impart a second bias on the drive shaft along the central longitudinal axis in a second direction opposite the first direction.

In accordance with another aspect of the disclosure, the method can further include forming the first bias member as a monolithic piece of material with an annular seal and forming the second bias member as a monolithic piece of material with the annular seal, and compressing the annular seal between first and second housing portions of the latch power actuator.

In accordance with another aspect of the disclosure, the method can further include stabilizing the first bias member and the second bias member against misalignment relative to the central longitudinal axis of the drive shaft to avoid imparting a side moment on the drive shaft.

In accordance with another aspect of the disclosure, the method can further include stabilizing the first bias member and the second bias member against misalignment relative to the central longitudinal axis of the drive shaft by capturing a central body portion of the first bias member and the second bias member in respective pockets of the first and second housing portions of the latch power actuator.

In accordance with another aspect of the disclosure, the method can further include capturing the central body portion of the first and second bias members in the pockets having a line-to-line fit or interference fit.

In accordance with another aspect of the disclosure, the method can further include disposing a first end of the first biasing member in engagement with the first end of the drive shaft and disposing a second end of the second biasing member in engagement with the second end of the drive shaft.

In accordance with another aspect of the disclosure, the method can further include disposing the first end of the first biasing member in a channel of the first end of the drive shaft and disposing the second end of the second biasing member in a channel of the second end of the drive shaft.

In accordance with another aspect of the disclosure, the method can further include providing the first bias member having a hollowed cavity between the first end of the first biasing member and the central body portion of the first bias member, and providing the second bias member having a hollowed cavity between the second end of the second biasing member and the central body portion of the second bias member.

Further areas of applicability will become apparent from the description provided herein. As noted, the description and any specific examples in this summary are intended for purposes of illustration only and are not intended to limit the scope of the present disclosure.

### BRIEF DESCRIPTION OF THE DRAWINGS

Other advantages of the present embodiments will be readily appreciated, as the same becomes better understood by reference to the following detailed description and appended claims when considered in connection with the accompanying drawings, wherein:

FIG. 1 illustrates a vehicle having at least one closure panel assembly including a latch assembly having a latch power actuator constructed in accordance with one aspect of the disclosure;

FIG. 2 is a plan view of a dry-side of a carrier assembly of a closure panel of the vehicle of FIG. 1 showing a latch power actuator fixed thereto with the latch power actuator being operably coupled to a latch to selectively operate the latch;

FIG. 3 is a plan view of the latch power actuator in accordance with the disclosure with a cover and some internal components thereof removed therefrom for clarity purposes only;

FIG. 4A is a fragmentary perspective view of FIG. 3 illustrating a bias member imparting a bias on an end of a drive shaft of the latch power actuator;

FIG. 4B is a plan view of FIG. 4A; and

FIG. 5 is a flow diagram illustrating a method of inhibiting axial play of a drive shaft of a latch power actuator in accordance with an aspect of the disclosure.

### DETAILED DESCRIPTION OF EXAMPLE EMBODIMENTS

The example embodiments will now be described more fully with reference to the accompanying drawings.

One or more example embodiments of a closure panel, illustrated as a vehicle door having a door module and a power actuator, are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

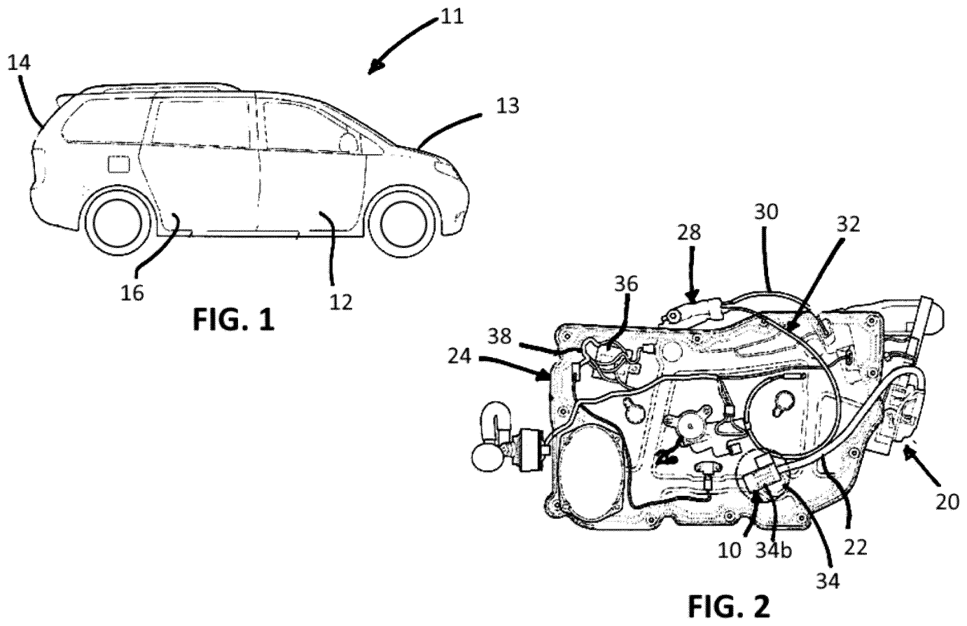

FIG. 1 shows a motor vehicle 11 having a plurality of closure panel assemblies, also referred to as closure panels, moveable between open and closed, cinched positions, including front door panel assemblies, also referred to as front door 12, a rear hatch lift gate closure panel assembly, also referred to as lift gate 14, a front hood 13, such as for covering a front trunk, also referred to as frunk, or for covering an engine, at least one sliding side door panel assembly, also referred to as sliding door 16. At least one or more of the aforementioned closure panels can have a cavity configured for receipt of a latch power actuator 10, also referred to as power actuator, constructed in accordance with one aspect of the disclosure. Power actuator 10 may be received or housed within other cavities, such as within a cavity of the vehicle body and/or at other locations provided in the vehicle 11, wherein power actuator 10, regardless of where located, may be configured as a cinch power actuator, also referred to as cinch actuator 10, to power a cinching operation, by way of example and without limitation. Illustratively, the term cinch is used herein to describe a powered movement of the closure panel assembly 14 from an opened position, typically partially opened, of the closure panel assembly 14 to a closed position of the closure panel assembly 14. For example, such a powered movement of the closure panel assembly 14 may include a powered movement from partially opened position of the closure panel assembly 14, corresponding to a secondary latched state of a latch assembly 20, whereat a ratchet of latch assembly 20 is in a secondary striker capture position, to a closed position of the closure panel assembly 14, corresponding to a primary latched state of the latch assembly 20, whereat ratchet of latch assembly 20 is in a primary striker capture position, such as disclosed in U.S. patent application Ser. No. 17/868,289, filed Jul. 19, 2022, entitled, “Closure Latch Assembly With Single Motor Multi-functional Power Actuator,” referred to hereafter as the '289 application, which is incorporated herein by way of reference in its entirety. The cinch actuator 10 is configured in operable communication with latch assembly 20 (FIG. 2), which is also received at least in part in the cavity of the closure panel assembly 14, via at least one of a rod or cable, such as a Bowden cable 22, by way of example and without limitation, to selectively communicate with and selectively (when commanded at a desired time) cinch the latch assembly 20. It is to be understood that cinch actuator 10 can be fixed directly to latch assembly 20, or contained within a common housing with all or substantially all components of latch assembly 20, such as discussed in the '289 application. The power actuator 10 is shown, by way of example and without limitation, attached to a dry side of a carrier 24, wherein dry side is referred to as the “dry-side” because, when carrier 24 is installed in the vehicle closure panel, the carrier 24 seals the passenger compartment of the motor vehicle 11 against the ambient external environment such that the dry side, which faces toward the passenger compartment, is protected from the external environment and remains dry.

Carrier 24 holds a variety of functional door hardware components. Generally speaking, the functional hardware components secured to carrier 24 can, as shown, include, among other things, the power-operated latch assembly 20, a power-operated window regulator 26, an inside handle unit 28 mechanically coupled to latch assembly 20 via an inside release mechanism 30 and via an inside lock/unlock mechanism 32. The connector mechanisms can be Bowden cables and/or rod-links, as is known. The functional hardware components are electrically coupled to an ECU 36, or an Electronic Control Unit, via a wiring harness 38.

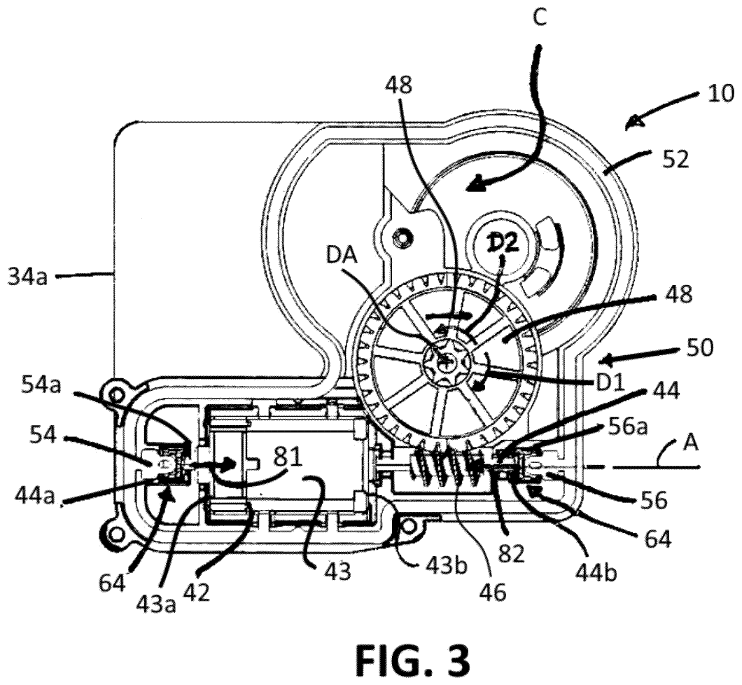

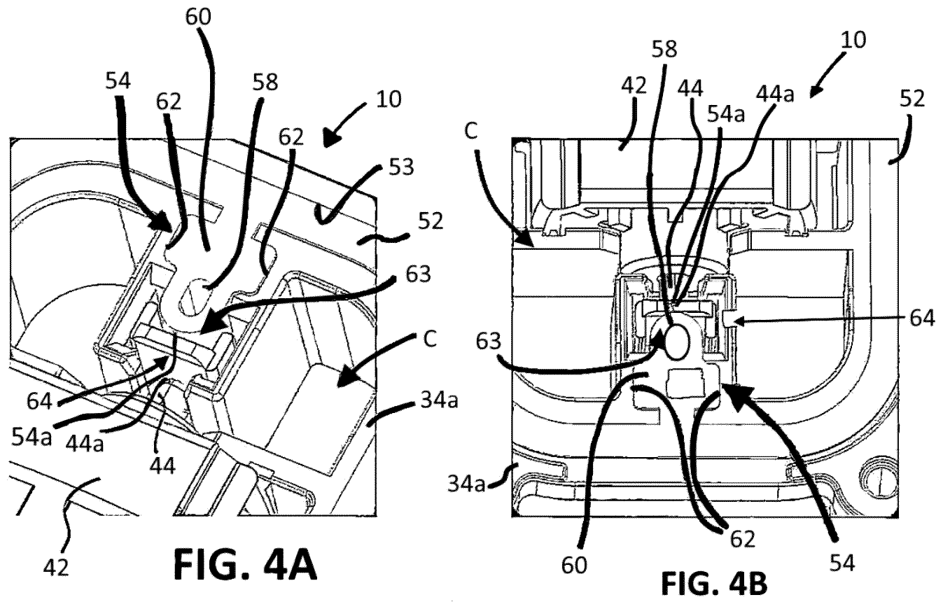

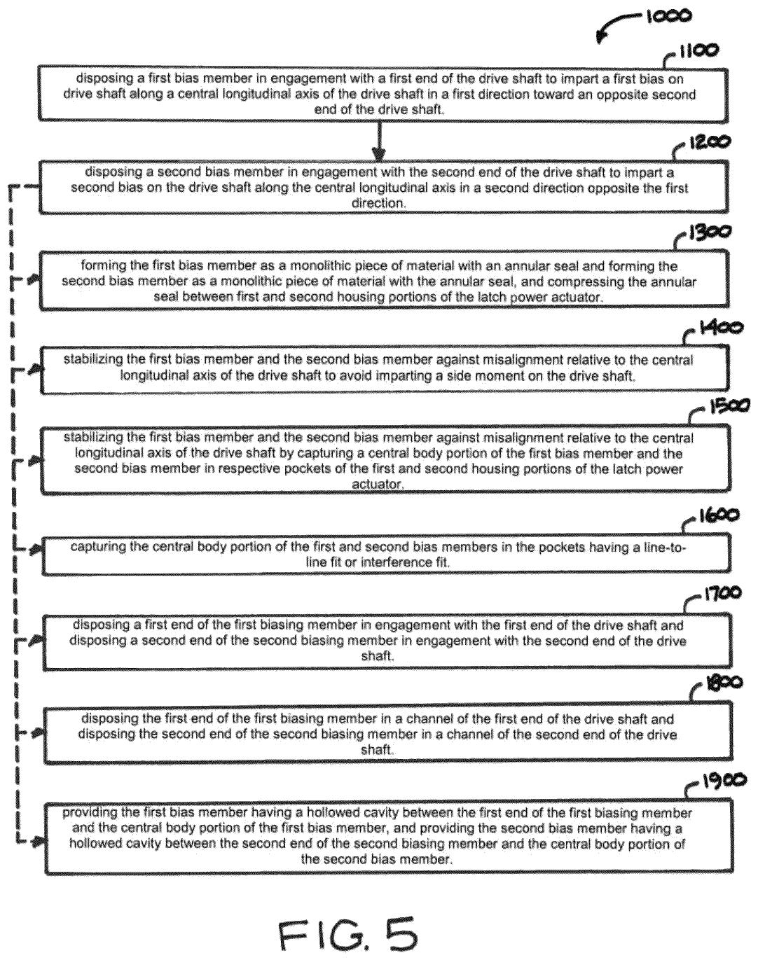

As shown in FIG. 2, the power actuator 10 includes a housing 34 having first housing portion, also referred to as upper housing portion 34a (FIGS. 3, 4A, and 4B), and a second housing portion, also referred to as lower housing portion 34b (FIG. 2). First and second housing portions 34a, 34b have respective annular outer annular peripheries configured for mating engagement with one another, and shown by way of example and without limitation as being mirrored with one another. To facilitate formation of a hermetic, water-tight seal between the first and second housing portions 34a, 34b, an annular seal 52 is disposed outwardly from and about a cavity C enclosed by the first and second housing portions 34a, 34b. Annular seal 52 can be made of any desired elastomeric, resilient seal material, including various types of rubber or other polymeric materials. Housing portions 34a, 34b can be formed of any suitable material, and are preferably formed of a molded non-metal material, such as a suitable plastic, polymeric material or composite material.

Power actuator 10 has an electric motor 42 supported in the cavity C between the first housing portion 34a and the second housing portion 34b. The electric motor 42 has a housing, also referred to as case 43, and a drive shaft 44 extending lengthwise through case 43 along a longitudinal central axis A of drive shaft 44, referred to hereafter as axis A, between opposite first and second ends 44a, 44b. First end 44a of shaft 44 extends axially away from a first end 43a of case 43 and the opposite second end 44b of shaft 44 extends axially away from an opposite second end 43b of case for concentric rotation of shaft 44 about the axis A in response to energization of the electric motor 42. Electric motor 42 is arranged in operable communication with ECU 36, such that ECU can send signals to electric 42 upon receipt of commands from actuation devices, such as a key fob, door handles, buttons, and sensors, by way of example and without limitation.

A drive gear 46, shown as a helical worm, referred to as worm, by way of example and without limitation, is fixed to drive shaft 44 for conjoint, coaxial rotation about axis A with drive shaft 44 in response to energization of motor 42.

A driven gear 48 is disposed within cavity C of the housing between the first housing portion 34a and the second housing portion 34b. Driven gear 48 is configured in meshed engagement with drive gear 46 for rotation in response to energization of motor 42. In the illustrated non-limiting embodiment, driven gear 48 is arranged to rotate about a driven gear axis DA that extends transversely to the axis A of drive shaft 44 and drive gear 46. It is to be understood that driven gear 48 can be an output gear or one of several gears of a gear assembly 50, also referred to as gear reduction or gear train 50, arranged in meshed engagement with one another to provide a desired rotational speed/torque output, as will be understood by a person possessing ordinary skill in the art. Accordingly, gear assembly 50 can be provided having as many intermeshed gears as desired to attain the speed and torque output desired to act on a drive member, also referred to as drive cable, or cable 22. Cable 22 can be attached to or operably coupled to a driven member, also referred to as output lever (not shown), wherein output lever is configured to move the ratchet of latch assembly 20 during a cinching operation.

The drive gear 46 can be driven in a first direction D1 of rotation in response to selective energization of motor 42, whereupon driven gear 48 is configured to rotate about the driven gear axis DA and operably drive cable 22 to cinch latch assembly 20 to a fully cinched state. Then, upon completing the cinching of ratchet, drive gear 46 is allowed to return in a second direction D2 of rotation, opposite the first direction D1 of rotation, such as in response to de-energization of motor 42 or reversing of polarity to motor 43 to reverse motor 43, by way of example and without limitation, thereby allowing driven gear 48 to rotate in an opposite direction about driven gear axis DA and to allow cable 22 to release latch assembly 20 and ratchet thereof from the cinched state to a non-cinched state.

To facilitate preventing ingress of contamination, such as dust and water, into cavity C, annular seal 52 is disposed outwardly from and about cavity C and compressed between first housing portion 34a and second housing portion 34b. Annular seal 52 can be disposed in an annular channel, also referred to as recess 53 formed in at least one of the housing portions 34a, 34b, if desired. To prevent axial movement and axial free play of drive shaft 44 along axis A, thereby preventing axial play between drive gear 46 and driven gear 48, a first bias member 54 extends inwardly from the annular seal 52 into engagement with one of the opposite ends, shown as the first end 44a, of the drive shaft 44 to impart a first bias B1 on drive shaft 44, with first bias B1 directed along the axis A in a first direction toward the other of the opposite ends, shown as the second end 44b of drive shaft 44. Further, a second bias member 56 extends inwardly from the annular seal 52 into engagement with the other of the opposite ends, shown as the second end 44b, of the drive shaft 44 to impart a second bias B2 on drive shaft 44, with the second bias B2 directed along the axis A in a second direction opposite the first direction toward the other of the opposite ends, shown as first end 44a of drive shaft 44. Accordingly, the first bias B1 and second bias B2 are opposite and equal forces opposing one another, acting to stabilize drive shaft 44 against unwanted axial movement along axis A. The first and second bias members 54, 56 can be formed as a monolithic piece of material with the annular seal 52. Accordingly, the first and second bias members 54, 56 are formed as a single, homogeneous, integral piece of material with the annular seal 52.

The first and second bias members 54, 56 function as spring members under constant compression, thereby imparting the constant coaxial bias B1, B2 in opposed directions to one another. As such, with an opposing constant axial bias imparted on drive shaft 44, axial play of the drive shaft 44 is prevented in each direction opposed to the respective constant axial bias B1, B2. As such, drive gear 46 and driven gear 48 are maintained in lash free, zero axial play, intermeshed relation with one another, thereby providing direct and immediate driving relation between drive gear 46 and driven gear 48 upon rotation of either relative to the other, while also preventing vibration and noise generation during use. The axial biases B1, B2, in addition to preventing axial play of drive shaft 44, also act to counter thrust forces imparted by drive gear 48 on drive shaft 44 along the axial direction defined by axis A, and further, inhibit and dampen vibration of drive shaft 44, thereby inhibiting the generation of noise from any vibration of drive shaft 44. As best shown in enlarged views of FIGS. 4A and 4B, the first and second bias members 54, 56 are each shown as having a hollowed core, also referred to as void or cavity 58, adjacent first and second ends 44a, 44b of drive shaft 44, thereby providing enhanced elasticity, noise dampening and spring properties. Between the cavities 58 and the annular seal 52, first and second bias members 54, 56 are shown as having enlarged portions, including an enlarged central body portion, referred to hereafter as central body 60, thereby providing first and second bias members 54, 56 having a cross-shape (FIGS. 4A, 4B). The enlarged central body 60 can be disposed in correspondingly shaped pockets 62 of at least one of first and second housing portions 34a, 34b, with the pockets 62 sized to provide a close fit, such as line-to-line or slight interference, with the central body 60, thereby acting to capture and stabilize the first and second bias members 54, 56 against lateral deflection in side-to-side misalignment from axis A, thus, maintaining the first and second bias members 54, 56 in symmetrical axial alignment with axis A and with first and second ends 44a, 44b of drive shaft 44. The pockets 62 can be formed as inwardly extending channels, also referred to as branch, off recess 53. Free ends, also referred to as terminal ends or first and second ends 54a, 56a of first and second bias members 54, 56, respectively, face inwardly from central body 60 and extend inwardly from pockets 62. Accordingly, central body 60 is located between the first and second ends 54a, 56a and seal 50. Cavities 58 are shown located between the first and second ends 54a, 56a and the enlarged central body 60, with cavities 58 extending inwardly from pockets 62. First and second ends 54a, 56a are shown extending into, also referred to as disposed within, pockets, also referred to as channels 63, bounded by end flanges 64 at the first and second ends 54a, 56a, with channels 63 shown fixed to and defining the first and second ends 54a, 56a of drive shaft 44, thereby further acting to stabilized first and second ends 54a, 56a and first and second bias members 54, 56 against lateral deflection in side-to-side misalignment from axis A. Accordingly, first and second bias members 54, 56 are maintained in co-axial, symmetrical alignment with axis A of drive shaft 44, thereby ensuring the bias imparted by first and second bias members 54, 56 is directed co-axially along axis A to avoid imparting a side moment on drive shaft 44.

When desired to move cinch actuator 10 to its engaged state, electrical power is selectively provided to motor 42 via wires (not shown), whereupon motor drive shaft 44 and drive gear 46 are rotated in a first driving direction, also referred to as actuating direction, thereby rotatably driving gear assembly 50, which ultimately drives/actuates cable 22 and causes latch assembly 20 to become cinched.

In accordance with another aspect of the disclosure, a method 1000 of inhibiting axial play of a drive shaft 44 of a latch power actuator 10 includes a step 1100 of disposing a first bias member 54 in engagement with a first end 44a of the drive shaft 44 to impart a first bias B1 on drive shaft 44 along a central longitudinal axis A of drive shaft 44 in a first direction toward an opposite second end 44b of the drive shaft 44. Further, a step 1200 of disposing a second bias member 56 in engagement with the second end 44b of the drive shaft 44 to impart a second bias B2 on drive shaft 44 along the central longitudinal axis A in a second direction opposite the first direction.

In accordance with another aspect of the disclosure, the method can further include a step 1300 of forming the first bias member 54 as a monolithic piece of material with an annular seal 52 and forming the second bias member 56 as a monolithic piece of material with the annular seal 52, and compressing the first bias member 54, the second bias member 56, and the annular seal 52 between upper and lower housing portions 34a, 34b of the latch power actuator 10.

In accordance with another aspect of the disclosure, the method can further include a step 1400 of stabilizing the first bias member 54 and the second bias member 56 against misalignment relative to the central longitudinal axis A of the drive shaft 44.

In accordance with another aspect of the disclosure, the method can further include a step 1500 of stabilizing the first bias member 54 and the second bias member 56 against misalignment relative to the central longitudinal axis A of the drive shaft 44 by capturing a central body portion 60 of the first bias member 54 and the second bias member 56 in respective pockets 62 of the first and second housing portions 34a, 34b of the latch power actuator 10.

In accordance with another aspect of the disclosure, the method can further include a step 1600 of capturing the central body portion 60 of the first and second bias members 54, 56 in the pockets 62 having a line-to-line fit or interference fit.

In accordance with another aspect of the disclosure, the method can further include a step 1700 of disposing a first end 54a of the first biasing member 54 in engagement with the first end 44a of the drive shaft 44 and disposing a second end 56a of the second biasing member 56 in engagement with the second end 44b of the drive shaft 44.

In accordance with another aspect of the disclosure, the method can further include a step 1800 of disposing the first end 54a of the first biasing member 54 in a channel 63 of the first end 44a of the drive shaft 44 and disposing the second end 56a of the second biasing member 56 in a channel 63 of the second end 44b of the drive shaft 44.

In accordance with another aspect of the disclosure, the method can further include a step 1900 of providing the first bias member 54 having a hollowed cavity 58 between the first end 54a of the first biasing member 54 and the central body portion 60 of the first bias member 54, and providing the second bias member 56 having a hollowed cavity 58 between the second end 56a of the second biasing member 56 and the central body portion 60 of the second bias member 56.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power actuator for a latch of a motor vehicle closure panel, comprising:
a housing;
an electric motor disposed within said housing, said electric motor having a drive shaft extending along an axis between opposite ends for rotation about said axis in response to energization of said electric motor;
a drive gear fixed to said drive shaft; and
a first bias member imparting a first bias along said axis in a first direction on one of said opposite ends of said drive shaft, and a second bias member imparting a second bias along said axis in a second direction, opposite said first direction, on the other of said opposite ends of said drive shaft.

2. The power actuator of claim 1, wherein the housing includes a first housing portion having a first annular outer periphery and a second housing portion having a second annular outer periphery, said first annular outer periphery and said second housing portion mating with one another.

3. The power actuator of claim 2, further including an annular seal compressed between said first housing portion and said second housing portion, said first bias member extending inwardly from said annular seal and said second bias member extending inwardly from said annular seal.

4. The power actuator of claim 3, wherein said first bias member and said second bias member are formed as a monolithic piece of material with said annular seal.

5. The power actuator of claim 4, wherein at least one of said first housing portion and said second housing portion has an annular recess, said annular seal disposed in said annular recess.

6. The power actuator of claim 5, wherein at least one of said first housing portion and said second housing portion has pockets, said first bias member and said second bias member each having an enlarged central body portion disposed in said pockets to inhibit misalignment of said first bias member and said second bias member relative to the axis of said drive shaft.

7. The power actuator of claim 6, wherein said opposite ends of said drive shaft have channels fixed thereto, said first bias member having a first end disposed in one of said channels and said second bias member having a second end disposed in the other of said channels.

8. The power actuator of claim 6, wherein said first bias member has a first end imparting said first bias on said drive shaft and said second bias member has a second end imparting said second bias on said drive shaft, said first bias member having a hollowed cavity between said first end and said enlarged central body portion of said first bias member, said second bias member having a hollowed cavity between said second end and said enlarged central body portion of said second bias member.

9. The power actuator of claim 1, wherein said opposite ends of said drive shaft have channels fixed thereto, said first bias member having a first end disposed in one of said channels and said second bias member having a second end disposed in the other of said channels.

10. The power actuator of claim 1, further including a driven gear disposed within said housing, said driven gear arranged in meshed engagement with said drive gear for rotation in response to rotation of said drive gear.

11. The power actuator of claim 10, wherein said driven gear is arranged to rotate about a driven gear axis, said driven gear axis extending transversely to said axis of said drive shaft, said first bias and said second bias inhibiting lash between said drive gear and said driven gear.

12. A method of inhibiting axial play of a drive shaft of a latch power actuator, comprising:
disposing a first bias member in engagement with a first end of the drive shaft to impart a first bias on drive shaft along a central longitudinal axis of the drive shaft in a first direction toward an opposite second end of the drive shaft; and
disposing a second bias member in engagement with the second end of the drive shaft to impart a second bias on the drive shaft along the central longitudinal axis in a second direction opposite the first direction.

13. The method of claim 12, further including forming the first bias member as a monolithic piece of material with an annular seal and forming the second bias member as a monolithic piece of material with the annular seal, and compressing the annular seal between first and second housing portions of the latch power actuator.

14. The method of claim 13, further including stabilizing the first bias member and the second bias member between the first housing portion and the second housing portion against misalignment relative to the central longitudinal axis of the drive shaft to avoid imparting a side moment on the drive shaft.

15. The method of claim 14, further including capturing a central body portion of the first bias member and the second bias member in pockets of the first housing portion and the second housing portion.

16. The method of claim 15, further including capturing the central body portion of the first bias member and the second bias member in a line-to-line or interference fit within the pockets of the first housing portion and the second housing portion.

17. The method of claim 15, further including disposing a first end of the first biasing member in engagement with the first end of the drive shaft and disposing a second end of the second biasing member in engagement with the second end of the drive shaft.

18. The method of claim 17, further including disposing the first end of the first biasing member in a channel of the first end of the drive shaft and disposing the second end of the second biasing member in a channel of the second end of the drive shaft.

19. The method of claim 17, further including providing the first bias member having a hollowed cavity between the first end of the first biasing member and the central body portion of the first bias member, and providing the second bias member having a hollowed cavity between the second end of the second biasing member and the central body portion of the second bias member.
